(19) United States
(12) Patent Application Publication
(10) Pub. No.: US 2026/0150864 A1
(43) Pub. Date: Jun. 4, 2026

(54) WHITE KIMCHI JUICE AND METHOD FOR PRODUCING SAME

(71) Applicant: STEVEN FOOD TECH CO., LTD., Seoul (KR)

(72) Inventor: Yun Kyung PARK, Gyeonggi-do (KR)

(21) Appl. No.: 18/578,333

(22) PCT Filed: Oct. 12, 2021
(86) PCT No.: PCT/KR2021/014006

§ 371 Date: Jan. 11, 2024

(30) Foreign Application Priority Data
Jul. 12, 2021 (KR) 10-2021-0091016

(51) Int. Cl. A23L 2/04; A23B 7/045; A23B 70/20; A23L 2/38; A23L 19/20

(52) U.S. Cl. CPC A23L 2/04; A23B 7/045; A23B 70/20; A23L 2/382; A23L 19/20

(57) ABSTRACT

The present invention provides a method for producing a white kimchi juice and a white kimchi juice produced thereby, the method comprising the steps of: (1) obtaining a juice by extracting white kimchi; (2) primarily aging the juice by refrigerating it at a temperature of 1 to 10° C.; (3) freezing the primarily aged juice; and (4) thawing the frozen juice by refrigerating it at a temperature of 1 to 10° C.

### TECHNICAL FIELD

The present invention relates to a white kimchi juice and a manufacturing method thereof, and more specifically, to a white kimchi juice that has improved taste, flavor, and texture at the same time by using white kimchi with its unique aroma and odor minimized, and can produce a sweet taste suitable for a food and beverage without adding any additional sugar during the juice manufacturing process, and a method for producing the same.

Furthermore, the present invention relates to a white kimchi juice that ensures uniform quality by minimizing the deterioration of the juice due to additional fermentation of the juice that may occur during the distribution process, and a manufacturing method thereof.

### BACKGROUND ART

Kimchi is a Korean traditional fermented food made by pickling radish, cabbage, cucumber, etc. in salt, mixing them with seasonings such as red pepper, garlic, green onion, ginger, and salted fish, and then fermenting them, and is an essential side dish on the Korean table.

In particular, white kimchi is a clean and refreshing kimchi cooked by stuffing cabbage with various seasonings without using red pepper powder and pouring brisket broth or fruit juice thereto, and is widely known for its unique light taste. The white kimchi is one of the foods that helps health by providing various vitamins and beneficial lactic acid bacteria necessary for the body. Recently, as the superiority of kimchi in taste and nutrition has been scientifically proven, the kimchi has been recognized as the world's best fermented food and is rapidly emerging as a global food.

However, despite the excellent efficacy of white kimchi itself as a fermented food, the white kimchi has the following problems, which hinder its use as a variety of foods and beverages and health foods.

First, the white kimchi is generally made using ingredients such as garlic, ginger, and salted fish, and thus, creates the unique seasoning scent, cabbage green smell, sour, salty, and astringent taste of white kimchi, which is a factor that lowers consumers' preference in the process of using the white kimchi as food and beverage or health food. Furthermore, for this reason, research and utilization related to juice using the white kimchi are further limited, and in fact, there is no research and utilization of juice using the white kimchi.

Second, since the white kimchi is a fermented food, changes in quality may occur due to unexpected fermentation during the distribution process that is essential for producing the white kimchi as food and beverage, thereby causing the problem of not being able to guarantee the constant quality of the product.

Third, food and beverages are generally sweetened to improve consumers' drinking preference, and for this purpose, sugar must be added. However, in order to utilize the efficacy of white kimchi as a fermented food, it is not desirable to add additional sugar, and rather, excessive addition of sugar can seriously damage its value as a health drink. Therefore, conventional white kimchi juice has a refreshing taste but lacks sweetness, so it has clear limitations as a beverage.

Accordingly, there is an urgent need for research on white kimchi juice that has improved taste, flavor, and texture by using white kimchi with its unique taste and smell minimized, and can produce a sweet taste even without adding sugar and thus meet the needs of consumers as a food and beverage, while guaranteeing the taste and quality of juice using white kimchi by minimizing the deterioration of the juice due to additional fermentation of the white kimchi that may occur during the distribution process.

### DISCLOSURE

### Technical Problem

The present invention has been devised to overcome the above-mentioned problems, and an object of the present invention is to provide a white kimchi juice that has guaranteed taste and flavor by minimizing the unique taste and smell of white kimchi, and a manufacturing method thereof.

In addition, another object of the present invention is to provide a white kimchi juice that can maintain excellent quality and the constant taste and flavor by minimizing the deterioration of the juice due to additional fermentation that may occur during the distribution process, and a manufacturing method thereof.

Furthermore, still another object of the present invention is to provide a white kimchi juice that can be sweetened without adding sugar in the manufacturing process of the white kimchi juice, thereby enhancing its marketability as a health drink.

### Technical Solution

In order to achieve the above-mentioned objects, the present invention provides a method for producing a white kimchi juice, the method comprising the steps of: (1) obtaining a juice by extracting white kimchi; (2) primarily aging the juice by refrigerating it at a temperature of 1 to 10° C.; (3) freezing the primarily aged juice; and (4) thawing the frozen juice by refrigerating it at a temperature of 1 to 10° C.

According to an embodiment of the present invention, the method for producing a white kimchi juice may be characterized in that the white kimchi in step (1) is aged for 7 to 30 days.

According to another embodiment of the present invention, the method for producing a white kimchi juice may be characterized in that the primary aging in step (2) is performed for 3 to 10 days.

According to yet another embodiment of the present invention, the method for producing a white kimchi juice may be characterized in that the freezing in step (3) is carried out at a temperature of −18° C. or lower.

In addition, according to an embodiment of the present invention, the method for producing a white kimchi juice may be characterized in that no sugar is added.

According to another embodiment of the present invention, the method for producing a white kimchi juice may be characterized in that the method further includes the step of refrigerating and aging at a temperature of 1 to 10° C. after step (4).

According to yet another embodiment of the present invention, the method for producing a white kimchi juice may be characterized in that the white kimchi juice in step (4) contains white kimchi solids in an amount of 1 to 10% by volume.

According to still another embodiment of the present invention, the method for producing a white kimchi juice may be characterized in that the juice of at least one of steps (1) to (4) above further includes a lactic acid bacteria active substance.

Additionally, the present invention provides a white kimchi juice that satisfies both (1) a sugar content of 4.0 to 5.0 Brix and (2) pH 3.5 to 4.5.

According to another embodiment of the present invention, the white kimchi juice may be characterized in that it contains white kimchi solids in an amount of 1 to 10% by volume.

### Advantageous Effects

According to the method for producing a white kimchi juice according to the present invention, the taste and flavor of juice using white kimchi can be greatly improved by minimizing the unique taste and smell of white kimchi.

In addition, according to the method for producing a white kimchi juice according to the present invention, the excellence and uniformity of the quality of white kimchi juice can be guaranteed by preventing unexpected deterioration of the white kimchi juice during the distribution process.

Furthermore, the white kimchi juice according to the present invention can produce a sweet taste without adding sugar in the manufacturing process of the white kimchi juice, thereby enhancing its marketability as a health drink.

### BEST MODES OF THE INVENTION

Hereinafter, embodiments of the present invention will be described in detail so as to be easily implemented by one of ordinary skill in the art to which the present invention pertains. The present invention may be embodied in a variety of forms and is not be limited to the embodiments described herein.

As mentioned above, the unique taste and smell of conventional white kimchi has been a factor in reducing consumers' preference in the process of using it as juice, and white kimchi had the problem of not being able to maintain the constant quality during the distribution process due to its fermentation.

Accordingly, in order to seek a solution to the above-mentioned problem, the present invention provides a method for producing a white kimchi juice, the method comprising the steps of: (1) obtaining a juice by extracting white kimchi; (2) primarily aging the juice by refrigerating it at a temperature of 1 to 10° C.; (3) freezing the primarily aged juice; and (4) thawing the frozen juice by refrigerating it at a temperature of 1 to 10° C.

Therefore, the unique taste and smell of white kimchi can be minimized to enhance the utilization and consumer preference for white kimchi juice, while minimizing the fermentation of white kimchi during the distribution process, thereby ensuring the excellence and uniformity of the quality of white kimchi juice using it. Further, the white kimchi juice can be sweetened without adding sugar during the manufacturing process thereof, improving its marketability as a health drink.

In step (1) of the present invention, white kimchi is squeezed to obtain juice.

The white kimchi juice according to the present invention may use white kimchi manufactured using raw materials of conventional white kimchi. Specifically, the white kimchi in step (1) may be prepared through the steps of: (1-1) selecting and cutting cabbage as a raw material for white kimchi, (1-2) salting the cut cabbage, and (1-3) mixing the salted cabbage with auxiliary ingredients to produce white kimchi.

In step (1-1) above, in order to provide a juice with minimized taste and smell unique to white kimchi according to the present invention, the cabbage may be cut into a suitable size for making the juice in consideration of the content of solids, which is a determining factor, but there is no particular limitation on thereon. The cabbage may be included in 75 to 85% by weight, preferably 80 to 85% by weight, based on the total weight of white kimchi.

Next, in steps (1-2) and (1-3), the taste and flavor of white kimchi may vary depending on the salt concentration of the cabbage, which is a raw material, and the type and composition of auxiliary ingredients, so the salt concentration of the cabbage and the auxiliary ingredients can be selected to be consistent with the purpose of the present invention. In particular, optimal conditions can be set to minimize the unique taste of white kimchi, such as saltiness, sourness, and astringency, as well as the unique smell, such as seasoning aroma and green smell in the juice of white kimchi. As a non-limiting example, the auxiliary ingredients may include radish, rice grass, green onion, garlic, carrot, onion, white sugar, and ginger, and refined salt and sea salt may be used to adjust the salt concentration.

In the present invention, the composition of the auxiliary ingredients is not specifically limited, but for example, the auxiliary ingredients may include 2 to 4% by weight of radish, 2 to 4% by weight of rice grass, 0.6 to 2% by weight of green onions, 0.5 to 1.5% by weight of garlic, 0.5 to 1.5% by weight of carrots, 0.5 to 1.5% by weight of onions, 0.3 to 1% by weight of white sugar, 0.1 to 0.5% by weight of ginger, 0.5 to 1.5% by weight of sea salt, 1 to 2% by weight of refined salt, and the remaining amount of purified water, which are mixed to make white kimchi, but are not limited thereto.

Meanwhile, in step (1), white kimchi aged for 7 to 30 days may be used to obtain the white kimchi juice.

White kimchi contains a large amount of lactic acid bacteria, which are beneficial bacteria and salt-tolerant bacteria, wherein the lactic acid bacteria may be fermented at this stage of fermenting and aging the white kimchi.

In this case, since the amount of lactic acid bacteria is a factor that determines the unique taste of white kimchi, the amount of lactic acid bacteria can be determined by adjusting the appropriate aging temperature and aging time in this step in consideration of the taste and flavor of the white kimchi juice to be finally produced.

As a non-limiting example of this aging time and temperature, the white kimchi may be aged at a temperature of 1 to 10° C., a typical refrigeration temperature, for 7 to 30 days, and more preferably at a temperature of 2 to 8° C. If white kimchi aged for less than 7 days is used, there may be a problem that the efficacy of white kimchi is reduced due to insufficient fermentation of beneficial bacteria. If white kimchi aged for more than 30 days is used, the lactic acid bacteria may ferment too much, hindering consumers' preference for white kimchi juice due to the sour and bitter taste or the strong aroma unique to white kimchi.

Meanwhile, as a method of aging white kimchi, a known aging method capable of improving the taste and flavor of the white kimchi juice of the present invention may be used, and for example, the white kimchi may be aged in an airtight container.

Next, the white kimchi is squeezed to obtain juice.

The white kimchi of the present invention may be squeezed by a conventional juicing method in accordance with the purpose of the present invention in consideration of the taste and flavor of the white kimchi juice. As a non-limiting example thereof, it may be juiced by a method including the steps of: washing and cutting white kimchi, pulverizing the cut white kimchi with a grinder, and squeezing the pulverized white kimchi, wherein the pulverizing may be performed using a mixer such as a green juicer, and the squeezing process may be performed using a non-woven fabric or a centrifuge.

Next, in step (2) of the present invention, the juice is primarily aged by being refrigerated at 1 to 10° C.

As in step (1) above, the lactic acid bacteria may also be fermented in the primary aging step of fermenting and aging the white kimchi juice. In this case, since the amount of the lactic acid bacteria is a factor that can control the unique aroma and taste of white kimchi in the white kimchi juice, the aging temperature and aging time can be adjusted in consideration of the taste and flavor of the white kimchi juice to be finally produced.

As a non-limiting example thereof, the white kimchi may be aged at a temperature of 1 to 10° C., a typical refrigeration temperature, for 3 to 10 days, and more preferably at a temperature of 2 to 8° C.

If the primary aging is performed at a temperature of less than 1° C., there may be a problem of not being able to obtain the desired sugar content of the white kimchi juice due to insufficient fermentation of the lactic acid bacteria. In addition, if the primary aging is performed at a temperature exceeding 10° C., the fermentation of lactic acid bacteria and the like may proceed excessively, thereby deteriorating the taste and flavor of the final white kimchi juice.

Meanwhile, if the primary aging period is less than 3 days, beneficial bacteria such as lactic acid bacteria may not be sufficiently fermented, thereby reducing the efficacy of white kimchi. If the primary aging period exceeds 10 days, the fermentation of lactic acid bacteria and the like may proceed excessively, thereby reducing the taste and flavor of the final white kimchi juice. In addition, as a method of aging white kimchi, a known aging method capable of improving the taste and flavor of the white kimchi juice of the present invention may be used, and for example, the white kimchi may be aged in an airtight container.

Next, in step (3) of the present invention, the primarily aged juice is frozen.

The purpose of the present invention is to produce a white kimchi juice with excellent taste and flavor and to ensure the excellence and uniformity of the quality of the white kimchi juice itself, and this purpose can be achieved through the freezing in step (3) above.

More specifically, in the present invention, a white kimchi juice having excellent taste and flavor can be prepared through step (3). That is, the freezing in step (3) can kill a significant number of lactic acid bacteria in the white kimchi juice or reduce their activity, and thus, the growth of lactic acid bacteria and the like cannot be controlled in white kimchi juice produced only through aging without performing the freezing process as in the present invention, thereby resulting in a problem of deteriorating the texture due to the sour, salty, and astringent taste unique to white kimchi. Accordingly, in the present invention, the lactic acid bacteria and the like grown in the primary aging process are killed or their activity is reduced during the freezing process in step (3) to minimize the sour, salty, and astringent tastes unique to white kimchi, thereby improving the taste and flavor of white kimchi juice.

In addition, in the present invention, the excellence and uniformity of quality of the white kimchi juice can be ensured through the above step (3).

More specifically, the freezing in step (3) can kill the lactic acid bacteria and the like or reduce the activity thereof as described above, and thus, at this stage, most of the existing lactic acid bacteria and the like can be killed, thereby minimizing additional fermentation of the white kimchi. Accordingly, in the white kimchi according to the present invention, the quality of the white kimchi juice can be improved by preventing changes in the taste and flavor due to additional fermentation and aging. In particular, the deterioration of the white kimchi juice can be prevented during the distribution process involved in producing the product, thereby preventing economic loss and ensuring the uniform quality of white kimchi juice provided to consumers.

To this end, in step (3), the white kimchi may be frozen at a temperature of −18° C. or lower. If the white kimchi is frozen at a temperature higher than −18° C., the lactic acid bacteria may ferment and proliferate, resulting in a decrease in the texture due to the sour, salty, and astringent tastes unique to the white kimchi. In addition, the white kimchi is additionally fermented and aged to change its taste and flavor, thereby making it impossible to guarantee the excellence and uniformity of the quality of the white kimchi juice.

In addition, taking into account the volume of the white kimchi juice to be finally produced under the above temperature conditions, the freezing must be carried out for a period of time that allows complete freezing. If the white kimchi juice is not completely frozen due to insufficient freezing time, the lactic acid bacteria and the like may not be sufficiently killed, thereby causing a problem in that the unique taste of the final white kimchi juice, such as sour, salty, and astringent tastes, and the scent of white kimchi are not minimized.

Next, in step (4) of the present invention, the frozen juice is refrigerated and thawed at a temperature of 1 to 10° C.

The refrigeration in this step is performed at a refrigeration temperature of 1 to 10° C. to completely thaw the white kimchi juice. If the white kimchi juice is thawed at a temperature of less than 1° C., the taste and flavor of the white kimchi juice may deteriorate as it moves to the secondary ripening stage of step (4-1) without being completely thawed. If the white kimchi juice is thawed at a temperature exceeding 10° C., the amount of fermented lactic acid bacteria and the like cannot be predicted, which may not only deteriorate the taste and flavor of the white kimchi juice, but also cause the problem of not being able to guarantee the uniform quality.

In addition, taking into account the volume of the white kimchi juice to be finally produced under the above temperature conditions, the thawing must be carried out for a period of time that allows complete thawing. If the white kimchi juice is not completely thawed due to insufficient thawing time, the amount of fermented lactic acid bacteria and the like cannot be predicted, which may not only deteriorate the taste and flavor of the white kimchi juice, but also cause the problem of not being able to guarantee the uniform quality.

After step (4), step (4-1) of refrigerating and aging at a temperature of 1 to 10° C., more preferably 1 to 4° C., may be further included.

In step (4-1), the frozen and thawed white kimchi juice is finally aged to minimize the unique taste and smell of white kimchi in the white kimchi juice and to greatly improve the taste and flavor of the white kimchi juice, which is the purpose of the present invention.

In addition, through this step, additional fermentation can be carried out in the white kimchi juice to obtain a refreshing sensation suitable for food and beverage, and sufficient sweetness can be achieved without adding sugar, making it drinkable by consumers and simultaneously improving the marketability of white kimchi juice as a health food.

More specifically, in the freezing step of step (3) described above, lactic acid bacteria and the like in the white kimchi juice may be killed or their activity may be reduced, and in this case, the lactic acid bacteria are not all killed and a small number remains, which can be fermented again in the aging stage of step (4-1). That is, the sour, salty, and astringent flavors unique to white kimchi are minimized through the freezing step of step (3), and then the white kimchi juice thawed in step (4-1) is secondarily re-aged, thereby inducing a softer texture to improve the flavor and at the same time creating a sugar content and refreshing feeling suitable for food and beverage.

In addition, the secondary aging period in step (4-1) is not particularly limited, but may preferably be 3 to 30 days in consideration of the volume of the white kimchi juice.

If the aging time in step (4-1) is less than 3 days, the small number of lactic acid bacteria remaining after freezing may not be sufficiently fermented, thereby causing the problem of not being able to obtain the desired sugar content and refreshing sensation. If the aging time exceeds 30 days, the fermentation of the lactic acid bacteria may proceed too much, thereby causing the problem that the unique taste of white kimchi cannot be minimized.

In addition, if the aging temperature is less than 1° C., the small number of lactic acid bacteria remaining after freezing may not be sufficiently fermented, thereby causing the problem of not being able to improve the sugar content. If the aging temperature exceeds 10° C., the fermentation of the lactic acid bacteria may proceed too much, thereby causing the problem that the unique taste of white kimchi cannot be minimized.

As described above, the present invention includes the additional process of freezing and re-aging the white kimchi juice, whereby the taste and smell unique to white kimchi can be minimized to improve the taste and flavor, and additional fermentation of the white kimchi that may occur during the distribution process can be suppressed to maintain the uniform quality. Furthermore, the white kimchi juice can produce a sweet taste without adding sugar in the manufacturing process of the juice, thereby enhancing its marketability as a health drink.

The white kimchi juice in step (4) may contain white kimchi solids in an amount of 1 to 10% by volume. The white kimchi solids can be added at any of the above-mentioned steps, but it is preferable to include the solids from the initial juicing step in that the lactic acid bacteria in the white kimchi juice can be controlled.

The white kimchi solid may be a major factor that determines the taste and aroma of white kimchi juice. Preferably, the white kimchi solid may be a white kimchi by-product remaining after white kimchi juice extraction.

More specifically, the white kimchi solid may be included in the white kimchi juice in an amount of 1 to 10% by volume to stimulate the texture and flavor of the white kimchi juice, thereby improving consumers' preference for the white kimchi juice. Furthermore, the fermentation of lactic acid bacteria in the white kimchi solids can produce a soft texture of white kimchi juice and a sugar content suitable for food and beverage.

If the white kimchi solid content is less than 1% by volume, a problem may occur in which the texture, sugar content, and flavor of the white kimchi juice cannot be improved. If the white kimchi solid content exceeds 10% by volume, there is a problem in that the fermentation of lactic acid bacteria in the white kimchi solid may not minimize the unique taste and smell of white kimchi in the white kimchi juice.

In addition, the present invention may further include a step (4-2) of refrigerating the white kimchi juice after step (4-1).

The step (4-2) is a step of refrigerating the finally produced white kimchi juice to ensure the quality, wherein the white kimchi juice may be refrigerated at a normal refrigeration temperature that can prevent its unexpected deterioration.

In addition, the step (4-2) may be a step of distributing the produced white kimchi juice as a raw material for food and beverage. Through step (4-2), the uniform quality of the white kimchi juice can be maintained.

Meanwhile, the white kimchi juice according to the present invention may contain a large amount of lactic acid bacteria, which are beneficial bacteria and salt-tolerant bacteria, but most of the lactic acid bacteria are killed or their activity is reduced through the freezing of step (3) described above. The lactic acid bacteria that survive through the refrigeration and thawing in step (4) and the re-aging in step (4-1) can proliferate again to control the population of lactic acid bacteria in the white kimchi juice. It is a lactic acid bacteria active substance that proliferates these lactic acid bacteria, wherein the lactic acid bacteria active substance may be a known substance that can re-proliferate the lactic acid bacteria, and for example, a synbiotic that only supports the activity of lactic acid bacteria without causing the growth of harmful bacteria such as Escherichia coli, excluding the lactic acid bacteria, but is not particularly limited thereto.

The synbiotics may refer to probiotics, prebiotics, or a mixture thereof. As a non-limiting example, the synbiotics may include both lactic acid bacteria themselves and yeast that serve as food for the lactic acid bacteria. More preferably, the synbiotics may include the lactic acid bacteria themselves and yeast, brewing yeast, and aspergillus yeast that serve as food for the lactic acid bacteria.

In addition, the lactic acid bacteria active material may be included in an amount of 0.05% to 0.5% by weight, preferably 0.1% to 0.5% by weight, of the total white kimchi juice. If the lactic acid bacteria active material is less than 0.1% by weight of the total white kimchi juice, there may be a problem of not being able to control the desired amount of lactic acid bacteria due to the relatively insufficient amount of the lactic acid bacteria active material. If the lactic acid bacteria active substance exceeds 0.5% by weight of the total white kimchi juice, the amount of the lactic acid bacteria cannot be sufficiently controlled, thereby deteriorating the taste and flavor of the white kimchi juice.

Meanwhile, the lactic acid bacteria active material may be included in the juice of at least one of steps (1) to (4), (4-1), and (4-2), and more preferably in step (4-1) or (4-2).

When the lactic acid bacteria active material is included in step (4-1), which may be a step of re-aging the thawed white kimchi juice as described above, harmful bacteria do not proliferate, and only the lactic acid bacteria that were mostly killed in step (3) can be selectively multiplied to control the population of lactic acid bacteria in the white kimchi juice. In this case, the population of lactic acid bacteria, which greatly affects the sugar content, odor, and flavor of the white kimchi juice, can be maintained at a constant level, thereby inducing a soft texture and improving the flavor of the white kimchi juice, while providing a sugar content and refreshing sensation suitable for food and beverage.

In addition, when the lactic acid bacteria active substance is included in step (4-2), which may be the step of distributing the white kimchi juice as described above, the amount of the lactic acid bacteria active material can be kept constant to control the population of the lactic acid bacteria, thereby preventing unexpected deterioration of the white kimchi juice during the distribution process and maintaining a constant taste and flavor. However, if the distribution process is excessively prolonged, the quality may be adversely affected, so it is advisable that the distribution period does not exceed a maximum of 4 months.

Next, the white kimchi juice according to the present invention will be described. However, in order to avoid duplication, the description of parts that overlap with that in the method for producing the white kimchi juice described above will be omitted.

The number of lactic acid bacteria in the white kimchi juice that has not gone through the freezing step of step (3) according to the present invention may be 300,000 to 2,000,000 per 1 mL of white kimchi juice. In the white kimchi juice in which most of the lactic acid bacteria have died or their activity has been reduced through the freezing of step (3) above, the number of lactic acid bacteria may be 500 to 1000 per 1 mL of the juice. In the case of white kimchi juice in which the lactic acid bacteria were grown by adding lactic acid bacteria active material in step (4-1) or step (4-2) after the thawing step, the number of lactic acid bacteria greatly increases and may be 200,000,000 to 600,000,000 per 1 mL of the juice.

As described above, the number of lactic acid bacteria in the white kimchi juice is a factor that determines the unique taste of white kimchi, and thus, can be adjusted through aging temperature, aging time, freezing, and the addition of lactic acid bacteria active substances. If the number of lactic acid bacteria in the white kimchi juice after the freezing of step (3) is less than 500, there may be a problem of not being able to obtain a soft texture and sugar content of the white kimchi juice suitable for food and beverage. If the number of lactic acid bacteria in the white kimchi juice exceeds 1,000, the unique sour and astringent taste of white kimchi cannot be minimized, thereby reducing consumers' preference for it as food and beverage.

In addition, the present invention provides a white kimchi juice that satisfies both the following relational expressions (1) and (2):
(1) a sugar content of 4.0 to 5.0 Brix
(2) pH 3.5 to 4.5.

The sugar content of the white kimchi juice satisfies 4.0 to 5.0 Brix.

The sugar content of white kimchi juice is a factor that determines consumer preference for food and beverages, and can be adjusted by lactic acid bacteria and solids. If the sugar content of the white kimchi juice is less than 4.0 Brix, the unique sour, salty, and astringent taste of white kimchi becomes stronger than the sweetness, thereby reducing consumers' preference for food and beverages. If the sugar content of the white kimchi juice exceeds 5.0 Brix, there may be a problem that the sweetness becomes too strong.

In addition, the white kimchi juice satisfies the pH of 3.5 to 4.5.

The pH of white kimchi juice is a factor that determines the sourness of white kimchi juice and thus can affect consumer preferences, and can be adjusted through aging temperature and aging period. If the pH of the white kimchi juice is less than 3.5, the sour taste may become too strong, and if the pH of the white kimchi juice exceeds 4.5, the flavor of the white kimchi juice may be reduced.

Lastly, the white kimchi juice may contain 1 to 10% by volume of white kimchi solids, which has the same technical features as those described in the method for producing white kimchi juice.

As described above, the present invention provides a method for producing a white kimchi juice, which comprises the steps of: (1) obtaining a juice by extracting white kimchi; (2) primarily aging the juice by refrigerating it at a temperature of 1 to 10° C.; (3) freezing the primarily aged juice; and (4) thawing the frozen juice by refrigerating it at a temperature of 1 to 10° C., a white kimchi juice that satisfies both the above relational expressions (1) and (2), thereby minimizing the unique taste and smell of white kimchi and greatly improving the taste and flavor of the juice. Furthermore, the fermentation of lactic acid bacteria contained in the white kimchi juice can be minimized during the distribution process, thereby preventing unexpected deterioration and ensuring the excellence and uniformity of the quality of the white kimchi juice.

Hereinafter, the present invention will be described in more detail by way of examples, but it should be understood that the following examples are not intended to limit the scope of the present invention, but to aid understanding of the present invention.

### Example 1

1.2 kg of cabbage was received as raw material. After removing the outer leaves and foreign substances, the cabbage was cut into two parts using a cutting machine. Then, based on the total weight of white kimchi, 82.8% of the cut cabbage was mixed with 1.2% of refined salt, 3.5% of radish, 4% of purified water, 2.5% of rice grass, 1.2% of green onion, 1% of garlic, 1% of carrot, 1% of onion, 1% of sea salt, 0.5% of white sugar, and 0.3% of ginger as auxiliary ingredients to prepare 1.5 kg of white kimchi.

Afterwards, the white kimchi was aged in an airtight container by maintaining a refrigeration temperature of 5° C. for 15 days, and then was juiced using a juicer to prepare 1000 ml of white kimchi juice containing 100 ml of white kimchi solids.

Then, the white kimchi juice was primarily aged in a refrigerator at 5° C. for 7 days, and then the aged white kimchi juice was completely frozen in a freezer at −20° C. Then, the frozen white kimchi juice was completely thawed in a refrigerator at 5° C., and the completely thawed white kimchi juice was secondarily aged at 5° C. for 14 days to prepare the final white kimchi juice.

Next, as described below, white kimchi juices were prepared under different conditions from Example 1, and are shown in Table 1 below.

### Example 2

White kimchi juice was prepared in the same manner as in Example 1, except that the primary aging time was 24 hours.

### Example 3

White kimchi juice was prepared in the same manner as in Example 1, except that the primary aging time was 20 days.

### Example 4

White kimchi juice was prepared in the same manner as in Example 1, except that the primarily aged white kimchi juice was frozen at −10° C.

### Example 5

White kimchi juice was prepared in the same manner as in Example 1, except that it was prepared to contain 15% by weight of white kimchi solids.

### Example 6

White kimchi juice was prepared in the same manner as in Example 1, except that the secondary aging temperature was −3° C.

### Example 7

White kimchi juice was prepared in the same manner as in Example 1, except that the secondary aging temperature was 13° C.

### Example 8

White kimchi juice was prepared in the same manner as in Example 1, except that after completely thawing the frozen white kimchi juice, it was secondarily aged at 5° C. for 14 days, and 3 g of lactic acid bacteria active substance (Seller: Lindimibang Co., Ltd., agricultural corporation, Product name: Synbiotic enzyme) was added.

### Comparative Example 1

White kimchi juice was prepared in the same manner as in Example 1, except that the primary aging temperature was 15° C.

### Comparative Example 2

White kimchi juice was prepared in the same manner as in Example 1, except that the primary aging temperature was −3° C.

### Comparative Example 3

White kimchi juice was prepared in the same manner as in Example 1, except that the frozen white kimchi juice was thawed by refrigerating it at 15° C.

### Comparative Example 4

White kimchi juice was prepared in the same manner as in Example 1, except that the white kimchi juice was not subjected to freezing and thawing processes.

### Comparative Example 5

White kimchi juice was prepared in the same manner as in Example 1, except that the frozen white kimchi was not subjected to a secondary aging process.

TABLE 1

| | Primary | Primary | | | Secondary | Secondary | White kimchi |
|---|---|---|---|---|---|---|---|
| | aging | aging | Freezing | Thawing | aging | aging | solid |
| | temperature | time | temperature | temperature | temperature | time | content |
| | (° C.) | (days) | (° C.) | (° C.) | (° C.) | (days) | (%) |
| Example 1 | 5 | 7 | −20 | 5 | 5 | 14 | 5 |
| Example 2 | 5 | 1 | −20 | 5 | 5 | 14 | 5 |
| Example 3 | 5 | 20 | −20 | 5 | 5 | 14 | 5 |
| Example 4 | 5 | 7 | −10 | 5 | 5 | 14 | 5 |
| Example 5 | 5 | 7 | −20 | 5 | 5 | 14 | 15 |
| Example 6 | 5 | 7 | −20 | 5 | −3 | 14 | 5 |
| Example 7 | 5 | 7 | −20 | 5 | 13 | 14 | 5 |
| Example 8 | 5 | 7 | −20 | 5 | 5 | 14 | 5 |
| Comparative | 15 | 7 | −20 | 5 | 5 | 14 | 5 |
| Example 1 | | | | | | | |
| Comparative | −3 | 7 | −20 | 5 | 5 | 14 | 5 |
| Example 2 | | | | | | | |
| Comparative | 5 | 7 | −20 | 15 | 5 | 14 | 5 |
| Example 3 | | | | | | | |
| Comparative | 5 | 7 | Not | 5 | 5 | 14 | 5 |
| Example 4 | | | frozen | | | | |
| Comparative | 5 | 7 | −20 | 5 | 5 | Not aged | 5 |
| Example 5 | | | | | | | |

### Experimental Example 1—Evaluation (1) of Physicochemical Properties of White Kimchi Juice

The pH of the white kimchi juice prepared in Examples 1, 4, and 8 and Comparative Examples 4 and 5 was measured at the Korea Functional Food Institute, and the results are shown in Table 2 below.

### Experimental Example 2—Evaluation (2) of Physicochemical Properties of White Kimchi Juice

The sugar content of the white kimchi juice prepared in Examples 1, 4, and 8 and Comparative Examples 4 and 5 was measured at the Korea Functional Food Institute, and the results are shown in Table 2 below.

### Experimental Example 3—Evaluation of Microbiological Properties of White Kimchi Juice

The number of lactic acid bacteria in the white kimchi juice prepared in Examples 1 and 8 and Comparative Example 4 was measured at the Korea Functional Food Institute, and the results are shown in Table 2 below. The white kimchi juice prepared in Example 4 and Comparative Example 5 was diluted by a 10-fold dilution method using sterilized saline solution and aerobically cultured at 36-37° C. for 72 hours using a Plate Count Agar with Brom Cresol Purple, and then, the yellow colonies generated thereafter were counted as colonies of lactic acid bacteria.

### Experimental Example 4—Sensory Evaluation of White Kimchi Juice

Sensory evaluation was performed on the white kimchi juice prepared in the above examples and comparative examples. The sensory evaluation was conducted on a scale of 10 points by 50 sensory evaluators who are familiar with food and beverage taste evaluation. The stronger the sweetness, sourness, astringency, cabbage greenness, and seasoning aroma, the higher the score. The overall preference was calculated as a score, and the scores were averaged and shown in Table 3 below.

TABLE 2

| | Number of lactic acid | Sugar | |
|---|---|---|---|
| | bacteria per 1 mL of | content | |
| | white kimchi juice | (Brix) | pH |
| Example 1 | 670 | 4.2 | 4.04 |
| Example 4 | 2012 | 4.0 | 5.21 |
| Example 8 | 470,000,000 | 4.6 | 3.91 |
| Comparative | 820,000 | 4.1 | 2.89 |
| Example 4 | | | |
| Comparative | 423 | 3.9 | 4.95 |
| Example 5 | | | |

TABLE 3

| | | | | Smell | | |
|---|---|---|---|---|---|---|
| | Taste | | | Cabbage | Seasoning | Overall |
| | Sweetness | Astringency | Sourness | greenness | aroma | preference |
| Example 1 | 8.5 | 5.5 | 4.0 | 4.0 | 5.0 | 9.3 |
| Example 2 | 8.0 | 7.0 | 5.0 | 6.0 | 6.5 | 7.5 |
| Example 3 | 8.0 | 8.0 | 8.5 | 8.0 | 8.5 | 5.1 |
| Example 4 | 8.6 | 8.0 | 9.0 | 9.0 | 8.0 | 4.8 |
| Example 5 | 8.0 | 7.5 | 7.5 | 7.0 | 7.0 | 6.5 |
| Example 6 | 6.5 | 6.8 | 7.0 | 6.0 | 7.0 | 6.9 |
| Example 7 | 8.0 | 8.5 | 8.3 | 8.4 | 8.5 | 4.6 |
| Example 8 | 9.0 | 5.0 | 4.4 | 4.0 | 4.5 | 9.4 |
| Comparative | 8.2 | 8.5 | 8.5 | 8.5 | 8.2 | 4.5 |
| Example 1 | | | | | | |
| Comparative | 6.0 | 7.0 | 6.5 | 7.0 | 6.0 | 6.2 |
| Example 2 | | | | | | |
| Comparative | 8.3 | 6.5 | 7.0 | 6.0 | 7.0 | 6.8 |
| Example 3 | | | | | | |
| Comparative | 7.0 | 9.5 | 9.5 | 9.0 | 8.5 | 2.2 |
| Example 4 | | | | | | |
| Comparative | 5.3 | 7.5 | 6.5 | 7.0 | 6.0 | 4.6 |
| Example 5 | | | | | | |

Referring to Tables 1 to 3 above, it can be seen that in the case of Example 1, which satisfies all the numerical ranges of the present invention with respect to the temperature and period of primary aging, freezing and thawing temperatures, and the temperature and period of secondary aging among the white kimchi juices prepared according to Examples and Comparative Examples, the overall preference of sensory evaluators was high as the taste and aroma unique to white kimchi were minimized. In addition, it can be seen that in the case of Example 8, in which lactic acid bacteria active substances were additionally added after going through a re-aging step after freezing, the overall preference of the sensory evaluators was the highest.

On the other hand, it can be seen that in the case of Comparative Example 4, in which the freezing step was omitted, the unique taste and aroma of white kimchi was evaluated as the strongest, and thus, the overall preference of the sensory evaluators was the lowest.

In addition, in the case of Comparative Example 5, in which the secondary aging step was omitted, the sweetness was evaluated as relatively low because some live lactic acid bacteria did not undergo a re-fermentation process after freezing, and although not listed in the table above, the overall preference of the sensory evaluators was low as the softness of the white kimchi juice was evaluated as the lowest.

In particular, it was confirmed through the evaluation results of Example 1 that when the white kimchi juice was frozen, most lactic acid bacteria were killed, but some lactic acid bacteria did not die and fermentation proceeded again through the secondary aging process, whereby the sugar content of the white kimchi juice was improved, the taste was softer, a refreshing feeling was added, and further, the unique sour, salty, and astringent tastes of white kimchi as well as the cabbage green smell and seasoning aroma are minimized, thereby producing the optimal juice suitable for food and beverage.

1. A method for producing a white kimchi juice, the method comprising the steps of:
(1) obtaining a juice by extracting white kimchi;
(2) primarily aging the juice by refrigerating it at a temperature of 1 to 10° C.;
(3) freezing the primarily aged juice; and
(4) thawing the frozen juice by refrigerating it at a temperature of 1 to 10° C.

2. The method for producing a white kimchi juice according to claim 1, wherein the white kimchi in step (1) is aged for 7 to 30 days.

3. The method for producing a white kimchi juice according to claim 1, wherein the primary aging in step (2) is performed for 3 to 10 days.

4. The method for producing a white kimchi juice according to claim 1, wherein the freezing in step (3) is carried out at a temperature of −18° C. or lower.

5. The method for producing a white kimchi juice according to claim 1, wherein no sugar is added.

6. The method for producing a white kimchi juice according to claim 1, wherein the method further includes the step of refrigerating and aging at a temperature of 1 to 10° C. after step (4).

7. The method for producing a white kimchi juice according to claim 1, wherein the white kimchi juice in step (4) contains white kimchi solids in an amount of 1 to 10% by volume.

8. The method for producing a white kimchi juice according to claim 1, wherein the juice of at least one of steps (1) to (4) above further includes a lactic acid bacteria active substance.

9. A white kimchi juice that satisfies both the following relational expressions (1) and (2):
(1) a sugar content of 4.0 to 5.0 Brix, and
(2) pH 3.5 to 4.5.

10. The white kimchi juice according to claim 9, wherein the white kimchi juice contains white kimchi solids in an amount of 1 to 10% by volume.
